(19) United States
(12) Patent Application Publication
(10) Pub. No.: US 2003/0047880 A1
(43) Pub. Date: Mar. 13, 2003

(54) Seal and method

(76) Inventor: Colby M. Ross, Carrollton, TX (US)

Correspondence Address: John F. Booth, CRUTSINGER & BOOTH, 1601 Elm Street, Suite 1950, Thanksgiving Tower, Dallas, TX, 75201, US

(21) Appl. No.: 09/949,372

(22) Filed: Sep. 7, 2001

(51) Int. Cl. F16L 17/025

(52) U.S. Cl. 277/626

(57) ABSTRACT

Disclosed is an improved annular well seal elements and method for installing and removing the elements from a subterranean well. The seal element has a plurality of slots formed in the seal element. During radial expansion of the seal element the slots are deformed to reduce hoop stresses in the seal due expansion.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### TECHNICAL FIELD

The present inventions relate to improvements in well seals used for sealing the annulus formed between concentric cylindrical surfaces such as the annulus between a tubing string and the bore of a surrounding casing. More particularly the present inventions relate to improvements in annulus seal elements and the apparatus and methods used to engage and disengage the seal elements.

### BACKGROUND OF THE INVENTION

In the course of treating and preparing subterranean wells for production, frequently seals are utilized to seal an annular spaced formed between concentric cylindrical surfaces. A typical example of the application of an annular seal is present when a well packer is run into the well on a work string, mandrel or production tubing. As used here “packer” is used to describe well apparatus sealing an annular space including but not limited to products sold and referred to in the industry as packers and bridge plugs and the like.

The purpose of a packer is to support production tubing and other completion equipment such as a screen adjacent to a producing formation and to seal the annulus between the outside of the production tubing and the inside of the well casing to block movement of fluids through the annulus past the packer location. The packer is provided with anchor slips having opposed camming surfaces which cooperate with complementary opposed wedging surfaces, whereby the anchor slips are radially extendible into gripping engagement against the well casing bore in response to relative axial movement of the wedging surfaces.

The packer also carries annular seal elements which when compressed axially expand radially into sealing engagement against the bore of the well casing and outside surface of the tubing. In these packers the internal diameter of the annular seal member remains unchanged during engagement. In other packer designs, the internal diameter of the seal element is expanded or enlarged during engagement. These later designs are referred to herein as propped elements. (See for example U.S. Pat. No. 5,311,938 to Henderson, et al., which is incorporated herein for all purposes.) In all designs packer engagement components are used to “set” the packer, i.e., engage the packer by moving the anchor slips into engagement with the casing bore and expanding the sealing element into sealing engagement with the casing bore. The setting forces may be generated hydraulically, electrically or mechanically.

After the packer has been set, it should remain in sealing engagement upon removal of the hydraulic or mechanical setting force. Moreover, it is essential that the packer remain locked in its set and sealed configuration while withstanding hydraulic pressures applied externally or internally from the formation and/or manipulation of the tubing string and service tools without unsetting the packer or interrupting the seal. This is made more difficult in deep wells in which the packer and its components are subjected to high downhole temperatures, for example, as high as 600 degrees F., and high downhole pressures, for example, 5,000 psi. Moreover, the packer should be able to withstand variation of externally applied hydraulic pressures at levels up to and exceeding 10,000 psi in both directions, and still be retrievable after exposure for long periods, for example, from 10 to 15 years or more.

The size of the annulus to be sealed and the annular clearance between the seal element and casing bore create an engineering dilemma in packer seal element design. If the annular clearance between the seal and casing bore is small, an unacceptable flow restriction is formed. As the tubing string is lowered into the well, well fluids must pass through this flow restriction forming a pressure drop across the unset annular seal element. Dislodgment of the seal element can occur resulting in a failure of the packer to properly seal. If the annular seal element clearance is left large enough to accommodate viscous well fluid flow, then seal element expansion requirements limit the choice of seal materials to softer, more flexible substances. The seal elements, when set, are subjected to high pressures which tend to cause the seal material to flow or extrude along the annular clearance and fail. To provide support for the seal elements metal back up rings are often used.

After long periods of extended service under extreme pressure and temperature conditions, it is desirable that the packer be retrievable from the well by appropriate manipulation of the tubing string to cause the packer to be released and unsealed from the well bore, with the anchor slips and seal elements being retracted sufficiently to be removed from the well bore.

Permanent packers are designed to permanently fix to the casing wall. Permanent packers are removed by milling. One of the major problems involved in removing a permanent packer is the presence of metal backup rings that bridge the gap between the packer and the casing to provide a support structure for the seal element to keep it from extruding out into the annulus. The problem with such an arrangement is that the large metal backup shoes act like a set of slips and will not release from the casing wall. Retrievable high-pressure packers also use backup rings that are difficult to retract when attempting to retrieve the packer and can sometimes require milling to remove.

### SUMMARY OF THE INVENTIONS

The present inventions contemplate an improved annular seal element and the associated processes and apparatus for engaging and disengaging the seal element used in the harsh conditions present in a well.

The present inventions contemplate the use of a seal, seal mounting and actuator design that allows the use of harder and more durable materials in the seal element to reduce failures and increase performance. For example seal elements formed from plastics and metals can be used instead of conventional soft rubber seal elements. These more durable materials are less likely to fail, for example by extrusion, or to be dislodged during installation. The present inventions also permit larger seal expansion ratios for a given hardness of seal material. This allows seal element designs with larger annular clearances and, in turn, less flow restriction during axial movement of the packer element.

One aspect of the present invention uses an annular seal element with a plurality of slots formed in the seal material. The slots deform when the seal element is radially expanded to reduce hoop stress. Preferably these slots have a substantially axial dimension. By designing seal elements in this manner, harder less resilient materials can be used to form the seal element. The term “slot” is used to refer to the various shapes and sizes of formations in the seal body. The term is used in its broadest generic sense to include all shapes and sizes of formations which extend into the surface, whether completely through the seal body or not.

The present inventions relate to apparatus for mounting and radially expanding the improved seal element. When yieldable materials are used in the seal element, axially movable ramps or wedges can be used to permanently deform the seal element into sealing shape by deforming the slots in the element and even by exceeding the elastic stress limit of the seal material.

By allowing the use of more durable seal element materials, present invention can be used, for example, to provide a retrievable packer or other well tool in which a reliable seal is maintained under high temperature and high pressure conditions for long service periods, where the lower outside element of a seal element assembly is subjected to high differential pressure fluctuations which may cause it to move relative to other seal elements of the assembly.

The novel features of the inventions are set forth with particularity in the claims. The invention will best be understood from the following description when read in conjunction with the accompanying drawings.

### BRIEF DESCRIPTION OF THE DRAWINGS

The accompanying drawings are incorporated into and form a part of the specification to illustrate several examples of the present inventions. These drawings together with the description serve to explain the principals of the inventions. The drawings are only for the purpose of illustrating preferred and alternative examples of how the inventions can be made and used and are not to be construed as limiting the inventions to only the illustrated and described examples. The various advantages and features of the present inventions will be apparent from a consideration of the drawings in which:

FIG. 1 is a side elevation view partially in section illustrating an embodiment of the improved seal element of the present invention shown in the run-in or unexpanded condition;

FIG. 2 is a side elevation view partially in section illustrating the seal element of FIG. 1 in the radially expanded or set condition;

FIG. 3 is an axial sectional view of one embodiment taken on line 3-3 of FIG. 1 looking in the direction of the arrows;

FIGS. 4-7 are axial section views similar to FIG. 3 of further embodiments;

FIGS. 8 a-c are sectional views of various embodiments of the seal element when taken on a line similar to line 8a-8a of FIG. 1 looking in the direction of the arrows;

FIG. 9 are views similar to FIGS. 8a-c illustrating alternative embodiments of seal elements according to the present invention;

FIGS. 10 a-i are plan views of several embodiments of the slots present in the seal elements of the present inventions;

FIG. 11 is a side elevation view partially in section illustrating a seal configuration according to the present invention;

FIG. 11a is an alternative embodiment of the seal configuration of FIG. 11;

FIG. 12 is a side elevation view partially in section illustrating a slip configuration in accordance with the present invention; and

FIGS. 13 and 14 illustrate a further embodiment of the present invention.

### DETAILED DESCRIPTION OF THE INVENTIONS

The present inventions are described by reference to drawings showing one or more examples of how the inventions can be made and used. In these drawings, reference characters are used throughout the several views to indicate like or corresponding parts.

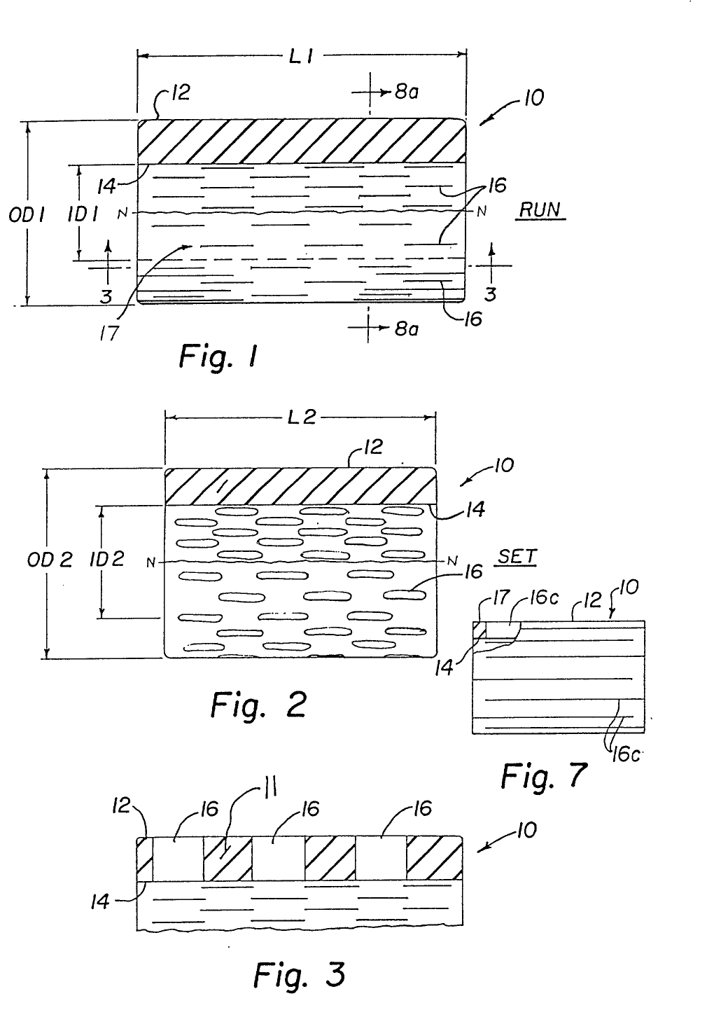

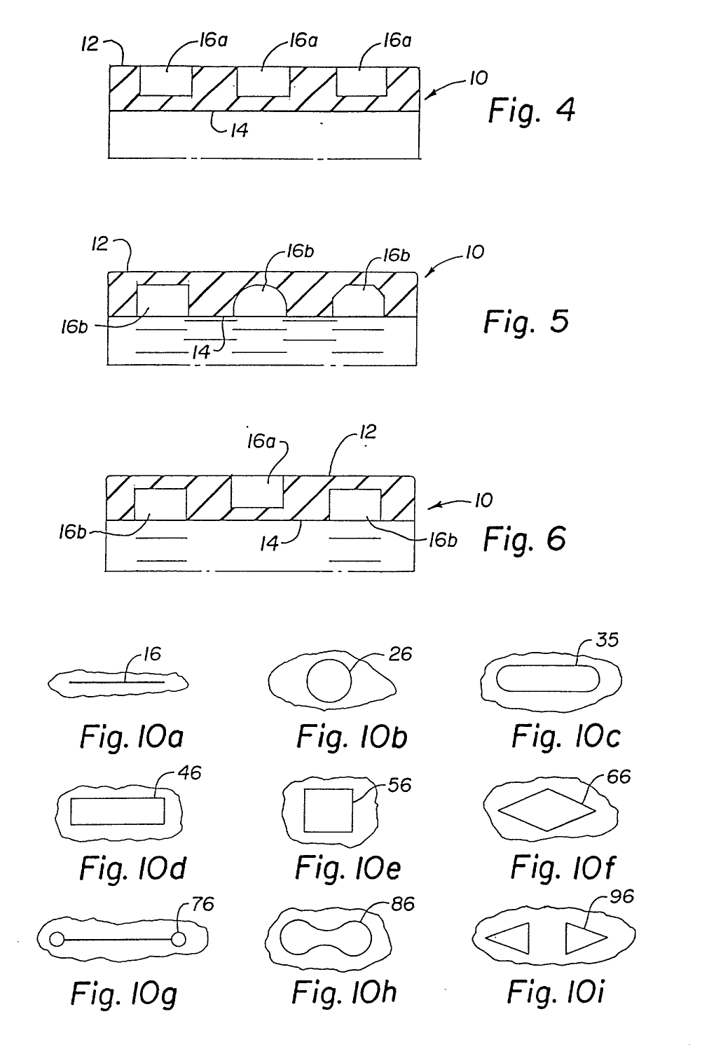

FIG. 1 is an embodiment of the improved seal element of the present inventions, which for purposes of description is designated by reference numeral 10. Although the improved annular seal configurations of the present inventions have application in a variety of downhole well devices, the following description will by example describe its use in a well packer such as the type shown in U.S. Pat. No. 5,311,938 issued May 17, 1994 entitled “Retrievable Packer For High Temperature, High Pressure Service”, which is incorporated herein by reference for all purposes. Seal element 10 would, for example, be used to replace propped seal element 30 in the U.S. Pat. No. 5,311,938 patent. In the illustrated embodiment, the packer element 10 has a smooth cylindrical outer seal surface 12 and a radially spaced smooth inner cylindrical seal surface 14. When unexpanded or in the run condition, as shown, the element 10 has an axial length L1 and outer diameter OD1.

According to the present invention the body of seal element 10 contains at least one slot 16 formed therein. In the illustrated embodiment, a plurality of slots 16 are present and the slots 16 comprise slits or cuts extending through the element 10 from outer surface 12 to inner surface 14. The slots 16 are illustrated arranged in a pattern of spaced axially extending rows 17, with the slots 16 in adjacent rows staggered or axially overlapping. In the unexpanded condition of FIG. 1 the slots 16 are axially extending in that they span a portion of the seal in the axial direction. The illustrated slots 16 extend parallel to the axis of the seal element, but it is envisioned that the slots 16 could be inclined from the illustrated position. Slots 16 could be arrange at an angle for example from zero to forty-five degrees from the illustrated position to extend both circumferentially and axially. Slots 16 need not be straight or planar and could be curved or even spiral around the element. The slots may, as shown, extend through element 10, or may extend only partially into element 10.

In FIG. 2 seal element is shown in the radially expanded or set condition. In U.S. Pat. No. 5,311,938, one manner of setting is described wherein the internal surface 14 is expanded or stretched over an enlarged cylindrical prop surface (not shown in this FIGURE). For purposes of this description a prop seal element will be used to refer to an annular seal that is radially expanded in whole or part by enlarging radially the internal seal supporting surface (prop surface). When set, the seal deforms as shown, the slots 16 are distorted or deformed from their slit shape into oval shapes. Note that the seal element has become axially shorter and radially enlarged. In the set condition the axial length L2 is less than the length L1 in the run condition. The diameter OD2 of the external surface 12 in the set condition is greater than the run OD1. The set diameter ID2 of the internal surface 14 is increased from ID1. The axially extending slots 16 increases the allowable radial inner diameter expansion ratio (R=ID2/ID1) for a given seal design and material. When a yieldable material is used for seal element 10, setting of the seal element can exceed the elastic limit of the material resulting in permanent deformation of the element. The element and its material should be selected so that even though the elastic limit is exceeded the ultimate strength is not.

At a given expansion ratio, the slots are believed to reduce hoop stresses in the seal element allowing the use of seal element made from stiffer deformable material. Not only does the seal design of the present inventions, allow the use of deformable materials currently in use, it also allows the design of seals from different deformable materials. For example, it is envisioned that the seal elements could be made entirely or partially from any one or more of the following deformable materials such as: yieldable materials including stainless steel; alloy steels; carbon steels; lead based alloys; copper alloys; zinc alloys; plastics; rytons; filled Teflon peek or resilient materials including nitrle; Viton; Fluorel; Aflas; and rubbers. The seal elements could be formed of a slotted metal frame coated with resilient sealing material such as rubbers, plastics and the like. Stiff or harder materials can be used which plastically deform during setting. In the embodiment shown in FIG. 1 the element 10 is made from steel.

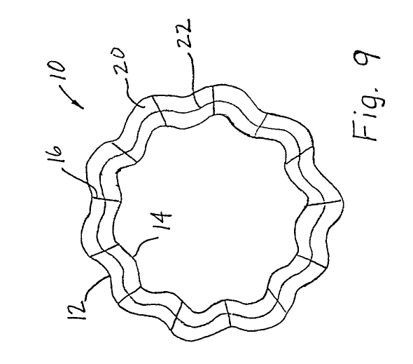

FIGS. 8 a-c illustrate the extension of the slots from the outer surface 12 to the inner surface 14. In FIGS. 3 and 8a slots 16 extend completely through the body 11 of seal element from the outer surface 12 to the inner surface 14. In FIG. 8b the seal comprises a slotted annular metal structure 18 coated with or surrounded by resilient or deformable material 20. The metal structure 18 in FIG. 8b is illustrated as being cylindrical but an axially or radially waved or corrugated structure 22 could be used and coated with resilient or deformable material 20, as in FIG. 8c. Further, the slotted annular metal structure 22 can be corrugated with the surrounding coating 20 corrugated as well, as shown in FIG. 9. The resilient or deformable material coating is illustrated as being slotted and relatively thick, it is envisioned that the resilient coating could be just as small as a few millimeters thick and depending on its thickness either slotted or unslotted. Also it is envisioned that the material 20 could be present on only one side of the metal structure 18

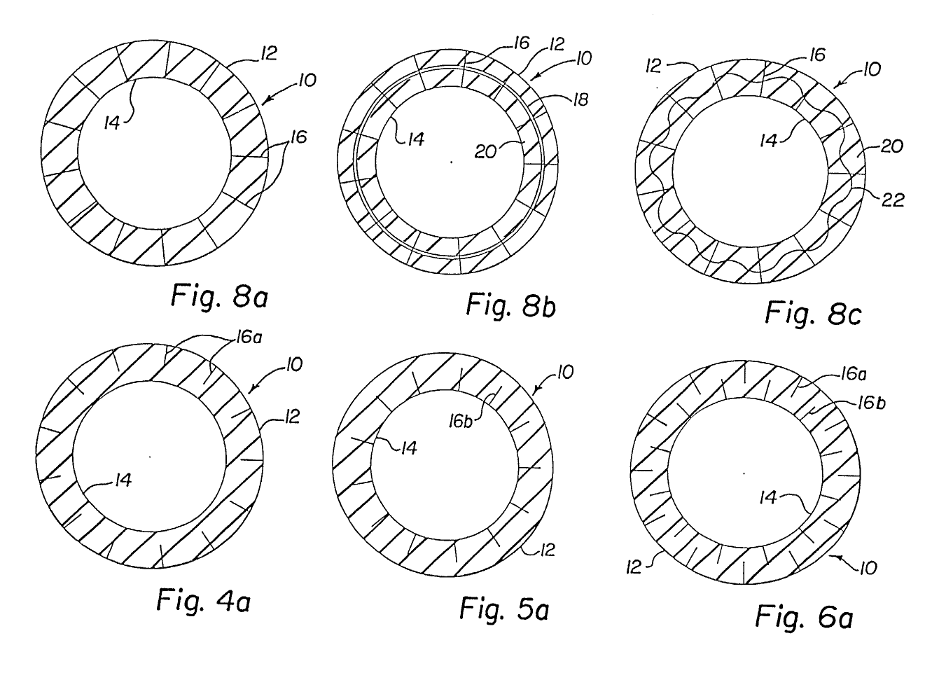

In FIGS. 4 and 4a slots 16a are blind slots in that they extend from the outer surface 12 but do not reach or extend to the inner surface 14. In FIGS. 5 and 5a, blind slots 16b extend from the inner surface 14 but do not reach the outer surface 12. In FIG. 6 the slots in a row alternate between slots 16a and 16b. In FIG. 6a, the slots in adjacent rows alternate between slots 16a and 16b. Other, embodiments (not shown) include mixing slot configurations 16, 16a and 16b along a given row and or mixing in adjacent rows.

FIG. 7 illustrates a seal slot pattern where slots 16c form the ends of the seal element 10 to just short of the opposite end leaving an unslitted portion 17. The slots 16c alternate with adjacent slots intersecting opposed ends of the element. Slots 16c could extend completely from surface 12 to 14 or could partially extend as shown in FIGS. 4a, 5a and 6a.

In FIGS. 10 a-i various embodiments of slot configurations are shown in plan view. In FIG. 10a, the slit shape 16 is shown. FIGS. 10b-i illustrate respectively a circular slot 26, oval or oblong slot 35, rectangular slot 46, square slot 56, diamond slot 66, slit shape with circular shaped end portions 76, irregular shape 86 and triangular shapes 96.

It is envisioned that any of the many possible slit shapes could be formed by molding the seal elements. Alternatively, the seal element could be initially formed and the slots machined or cut into the body, thereafter the body could be axially and radially deformed until the slots collapse to the shape of slots 16. It is envisioned that the seal body could be initially formed with slits in its set shape (for example like FIG. 2) and then deformed to the run or compressed shape (for example like FIG. 1) with its slits axially extending.

FIG. 11 illustrates the seal and slip portion of a permanent well packer 100 in the run condition positioned in a casing 102 according to the present inventions. Annular actuator 104 is mounted on mandrel 106. Actuator 104 is axially moved on the mandrel by mechanical or hydraulic means (not shown). Actuator 104 is positioned adjacent and in contact with one of two slip assemblies 108. Positioned adjacent each of the slip assemblies are slip wedges and seal prop members 110. Members 110 have sliding seals 112, which seal the annulus between the member and the mandrel. A seal element 114, slotted at 116 in accordance with the present invention, is positioned between the members 110. Facing conical shaped ramp or wedge surfaces 118 on the seal element and the members are use to stretch or radially expand the seal element into sealing engagement with the internal wall of the casing 102 when actuator 104 is engaged. The embodiment of FIG. 11 could be simplified for a weight down packer basically by using only half, one slip assembly and one prop member. Although the embodiment shown uses a seal element and prop member with facing conical ramp surfaces, ramps of different shapes could be used and seal elements with substantially constant cross section thickness could be used.

According to the present invention the slip assemblies 108 could be constructed as annular metal slips with teeth 122 formed on their exterior surface. Slips with slots 124 according to the present inventions could be made of steel and permanently expanded to engage the casing. If removal of permanently deformed slips or seal elements is anticipated, a raised lip 120 could be formed to allow a wedge cutter or the like to be used for disengagement.

In FIG. 11a seal element 114 is shown with interlocking arrangement with the prop members 110. In the illustrated embodiment dovetail grooves 130 are used. It is envisioned that to remove the seal element, the prop members 110 could be moved away from each other during unsetting to stretch the seal element 114 to the unset condition shown in FIG. 11a.

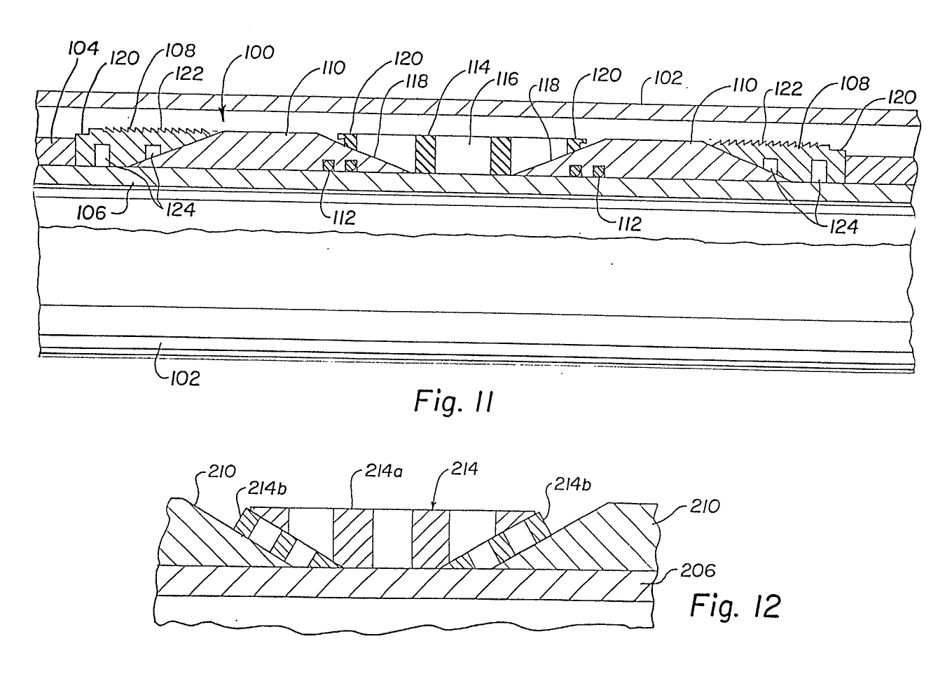

In FIG. 12 an alternative embodiment of the prop seal element 214 is shown. In this embodiment, the element comprises a deformable annular body 214a and two relatively stiffer annular portions 214b. Both the body 214a and portions 214b are slotted in accordance with the teaching of FIGS. 1-11 and are deformed during setting. The portions 214b contact the ramp surfaces on prop members 210 and act as back up or anti extrusion rings.

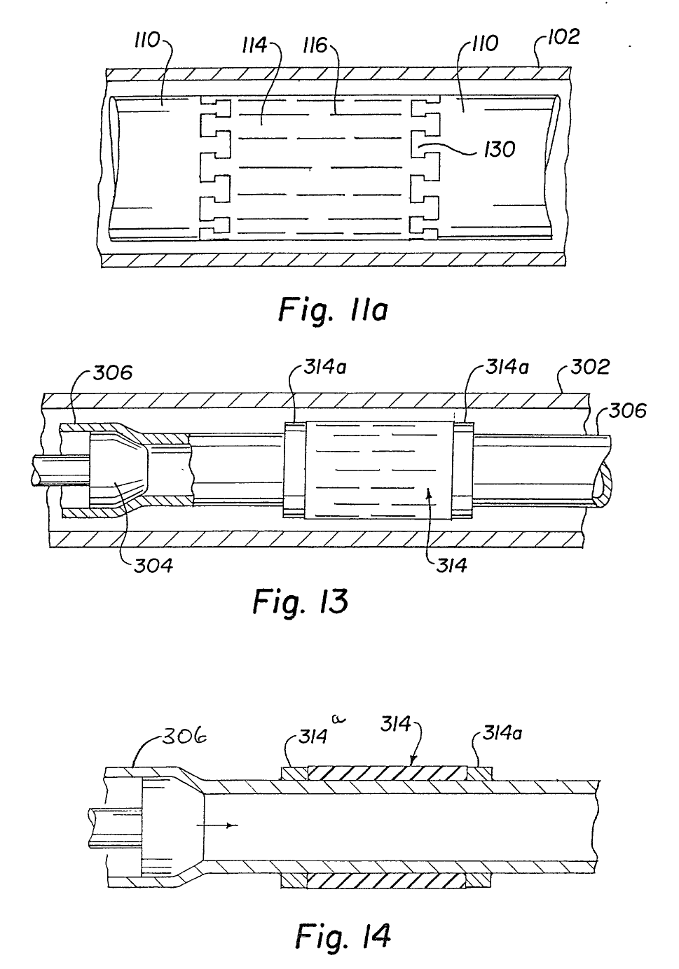

FIGS. 13 and 14 seal element 314 is positioned on the exterior of an expandable tubular member 306. An extruding member 304 is illustrated deforming tubular 306 in to a deformed or expanded shape 306a. If necessary the seal element 314 can be held in position on the member by annular welds 314a (or annular members connected to the tubular 306) positioned at each end of the seal element 314. The seal element 314 is slotted at 316 according to the configurations described in FIGS. 1-12. According to this embodiment of the invention the element 314 will be expanded with the tubular 306 and will contact the casing 302 to seal the annulus between the tubular 306 and casing 302.

The seal element shapes and setting apparatus in the embodiments shown and described above are only exemplary. Many details are found in the art relating to seal element in packers, bridge plugs, casing patches or the like. To describe the present invention the inner and outer seal elements are illustrated as being smooth, but it is envisioned that these surfaces could be irregular, dimpled, ridged, ringed, waffled or otherwise irregular or scuffed up. Therefore, many such details are neither shown nor described. It is not claimed that all of the detail parts, elements, or steps described and shown were invented herein. Even though numerous characteristics and advantages of the present inventions have been set forth in the foregoing description, together with details of the structure and function of the inventions, the disclosure is illustrative only, and changes may be made in the detail, especially in matters of shape, size and arrangement of the parts within the principles of the inventions to the full extent indicated by the broad general meaning of the terms used in the attached claims.

The restrictive description and drawings of the specific examples above do not point out what an infringement of this patent would be, but are to provide at least one explanation of how to make and use the inventions. The limits of the inventions and the bounds of the patent protection are measured by and defined in the following claims.

What is claimed is:

1. A radially expandable seal element for sealing the annular space between outer and inner members comprising;
an annular shaped body of deformable material of a size and shape to fit in said annular space and at least one axially extending slot formed in the surface of the body.

2. The seal of claim 1 wherein the body has an internal seal surface and a radially spaced external seal surface and wherein the at least one slot extends between the external seal surface and the internal seal surface.

3. The seal of claim 1 wherein the body has an internal seal surface and a radially spaced external seal surface and wherein the at least one slot does not extend between the external seal surface and the internal seal surface.

4. The seal of claim 1 wherein the body has an internal seal surface and a radially spaced external seal surface and wherein the at least one slot extends from the external seal surface.

5. The seal of claim 1 wherein the body has an internal seal surface and a radially spaced external seal surface and wherein the at least one slot extends from the internal seal surface.

6. The seal of claim 1 wherein the at least one slot is a slit.

7. The seal of claim 1 wherein the at least one slot is diamond shaped.

8. The seal of claim 1 wherein the at least one slot is polygonal shaped.

9. The seal of claim 1 wherein the slots are oval shaped.

10. The seal of claim 1 where the slot has substantial axial dimension

11. The seal of claim 1 additionally comprising a layer of resilient material on the body.

12. The seal of claim 1 wherein the body is made from the group consisting of metals, plastics, and elastomers, etc

13. The seal of claim 1 wherein the seal body is made from yieldable material.

14. The seal of claim 1 where in the body is at least partially coated with resilient material.

15. The seal of claim 1 wherein cross section thickness of the body varies axially.

16. The seal of claim 1 additionally comprises a lip on the body.

17. The seal of claim 1 wherein the body is formed from yieldable material.

18. The seal of claim 1 wherein the at least one slot comprises a plurality of slots arranged in a staggered pattern on the body.

19. An apparatus for sealing the axial passageway in a tubular member, comprising;
a seal element having an annular shaped body of deformable material, the body being of a size and shape to fit in said passageway and at least one axially extending slot formed in the surface of the body; and
a support member having an annular exterior surface engaging the seal element.

20. The apparatus of claim 19 wherein the support member is a prop member.

21. The apparatus of claim 20 wherein the seal element engaging support surface on the prop member is tapered.
